(19) United States
(12) Patent Application Publication
(10) Pub. No.: US 2026/0034921 A1
(43) Pub. Date: Feb. 5, 2026

(54) System for Anchoring a Safety Seat, in Particular for a Child, to the Seat of a Vehicle, and Method Thereof

(71) Applicant: Italdesign-Giugiaro S.p.A., Torino (TO) (IT)

(72) Inventor: Francesco Ruocco, Moncalieri (IT)

(21) Appl. No.: 19/099,188

(22) PCT Filed: Jul. 25, 2023
(86) PCT No.: PCT/IB2023/057531

§ 371 Date: Jan. 28, 2025

(30) Foreign Application Priority Data
Jul. 28, 2022 (IT) 102022000016089

(51) Int. Cl. B60N 2/28; B60N 2/02; B60N 2/26

(52) U.S. Cl. CPC B60N 2/2893; B60N 2/0264; B60N 2/267; B60N 2/269

(57) ABSTRACT

A system for anchoring a safety seat, in particular for a child, to the seat of a vehicle includes at least one connector having a housing adapted to house at least a portion of an anchorage element constrained to the seat, wherein the at least one connector includes a hooking element, in particular of the clamp type with controlled opening/closing, for hooking the connector to the anchorage element and obtain a mechanical fastening between the safety seat and the seat, and wherein the at least one connector includes an actuator for controlling or driving the opening and closing of the hooking element, so as to allow the connector to be coupled to and decoupled from the anchorage element. The at least one connector and the at least one anchorage element include an electric element that permits electric current and/or data to flow from the anchorage element to the connector, and vice versa.

### BACKGROUND OF THE DISCLOSURE

### 1. The Field of the Disclosure

The present invention relates to a system for anchoring a safety seat, in particular for a child, to the seat of a vehicle. The present invention also relates to a method for anchoring a safety seat, in particular for a child, to the seat of a vehicle.

### 2. The Relevant Technology

Ever since motor vehicles have been produced and marketed, i.e., since the beginning of the 20th century, many systems have been used for restraining and protecting the driver or the passengers of motor vehicles.

Most restraint systems were created to protect adults only, and no particular measure was adopted for small children.

Production of child safety seats started in the early thirties: however, their main goal was not safety, but raising the child to make him/her more easily visible by an adult, in particular by an adult driving the vehicle.

As time went by, several different restraint systems were developed with also child protection in mind.

A first type of system for anchoring a child safety seat to the seat of a vehicle makes use of a standard safety belt, which, as is known, is a passive safety system anchored inside the vehicle that, in the event of a collision, will keep the occupant's body bound to the seat, preventing the occupant from hitting the internal structures and being thrown out of the passenger compartment of the vehicle.

However, this first type of anchorage system has many drawbacks, in that the anchoring operation is excessively difficult and uncomfortable.

Moreover, when anchoring the safety seat by means of the safety belt, the user is left in doubt as to the correct installation of the safety seat and of the various parts thereof. This should not happen, because a properly installed safety seat can make a substantial difference in the event of an accident.

A second type of system for anchoring a child safety seat to the seat of a vehicle is known as ISOFIX (ISO standard 13216).

Starting from year 2006, in fact, for all automotive manufacturers it has become mandatory to install ISOFIX anchor points in the passenger compartment of their vehicles, as well as to indicate the presence of such a system in the car's instruction manual.

This provision represented a very important step towards a higher level of child safety in cars; as a matter of fact, the ISOFIX system permits fastening the child seat directly to a seat of a vehicle by means of special components, so as to create and obtain a firm connection between the safety seat and the car's seat.

The ISOFIX anchorage system is a standardized international system that uses a simple and effective mechanism: the safety seat's base is equipped with two universal connectors that are inserted into corresponding anchor points provided in the car's seat, in particular between the cushion and the back of the seat; in this way, the child safety seat is fastened directly to the car's seat, and a rigid connection is established between the child safety seat and the vehicle's chassis.

In particular, the ISOFIX system comprises the following components:
anchor points in the car: they usually consist of two rectangular metal rings, typically made of steel, fixed or welded to the vehicle's seat frame and positioned along the line that joins the seat back to the seat cushion, at a mutual distance of approx. 280 mm.
connectors on the safety seat: they usually consist of controlled-opening clamps provided on the safety seat, to be hooked up to the anchor points provided on the vehicle's seat, thus creating a rigid connection between the vehicle's seat and the safety seat.

The ISOFIX system may further comprise a third anchor point (also referred to as “anti-overturning” anchor) adapted to prevent any rotational or overturning movement of the safety seat, wherein said third anchor point consists of a stabilizer strap (also known as “top tether”), usually located in the upper part of the safety seat, to be hooked up to an anchor point usually located on the rear side of the vehicle's seat back.

Systems equipped with a third anchor point are defined as “Universal Isofix” to distinguish them from the “semi-universal Isofix” version, in which the system comprises a foot prop (also known as “support leg”), i.e., a sort of bracket or leg anchored to the safety seat or to the vehicle's floor which is arranged perpendicular to the vehicle's floor and acts as a support for the safety seat.

Another “semi-universal Isofix” system uses a safety belt to be coupled to the safety seat in order to prevent any rotational or overturning movement of the latter.

Nevertheless, even the ISOFIX anchorage systems known in the art suffer from a few drawbacks.

In fact, even if the connection between the car's anchor points and the safety seat's connectors is signalled by special indicators located directly on the anchor points or by other mechanical elements suitable for providing such indications, with the ISOFIX anchorage systems known in the art it is impossible to know with certainty if a safety seat equipped with an ISOFIX connector has been actually installed in the vehicle.

Moreover, the ISOFIX anchorage systems known in the art do not permit verifying that the safety seat has been correctly installed and fastened to a seat of the vehicle.

A further drawback of the ISOFIX anchorage systems known in the art lies in the fact that they do not permit detecting the presence of a child in the safety seat, and do not allow an adequate management of critical scenarios, such as, for example, (in addition to the presence of a child in the seat) those related to the possibility that the driver of the vehicle may have forgotten a child inside an unattended car.

### SUMMARY OF THE DISCLOSURE

In this frame, it is the main object of the present invention to provide a system for anchoring a safety seat, in particular for a child, to the seat of a vehicle, wherein said system has been so conceived as to overcome the drawbacks of the prior art.

In particular, it is one object of the present invention to provide a system for anchoring a safety seat, in particular for a child, to the seat of a vehicle, wherein said system has been conceived to permit knowing with certainty if a safety seat has been actually and correctly installed in the vehicle.

It is another object of the present invention to provide a system for anchoring a safety seat, in particular for a child, to the seat of a vehicle, wherein said system permits knowing if a child is present inside the vehicle and also permits an adequate management of critical scenarios, optionally envisaging the transmission of an alarm message in the event that the safety seat has not been installed correctly and/or in the event that a child has been forgotten in said vehicle.

It is a further object of the present invention to provide a system for anchoring a safety seat, in particular for a child, to the seat of a vehicle, wherein said system can be easily manufactured and installed, even on existing systems.

It is yet another object of the present invention to provide a system for anchoring a safety seat, in particular for a child, to the seat of a vehicle, wherein said system is characterized by a wide range of applications.

Said objects are achieved by the present invention through a system for anchoring a safety seat, in particular for a child, to the seat of a vehicle incorporating the features set out in the appended claims, which are intended as an integral part of the present description.

### BRIEF DESCRIPTION OF THE DRAWINGS

Further objects, features and advantages of the present invention will become apparent in light of the following detailed description and of the annexed drawings, which are provided herein merely by way of non-limiting explanatory example, wherein:

FIG. 1 is a perspective view of a system for anchoring a safety seat, in particular for a child, to the seat of a vehicle;

FIGS. 2a to 2c are different views of a first embodiment of a system for anchoring a safety seat, in particular for a child, to the seat of a vehicle in accordance with the present invention;

FIGS. 3a to 3d are different views of a second embodiment of the system for anchoring a safety seat in accordance with the present invention;

FIGS. 4a and 4b are different views of a third embodiment of the system for anchoring a safety seat in accordance with the present invention.

### DETAILED DESCRIPTION OF THE PREFERRED EMBODIMENTS

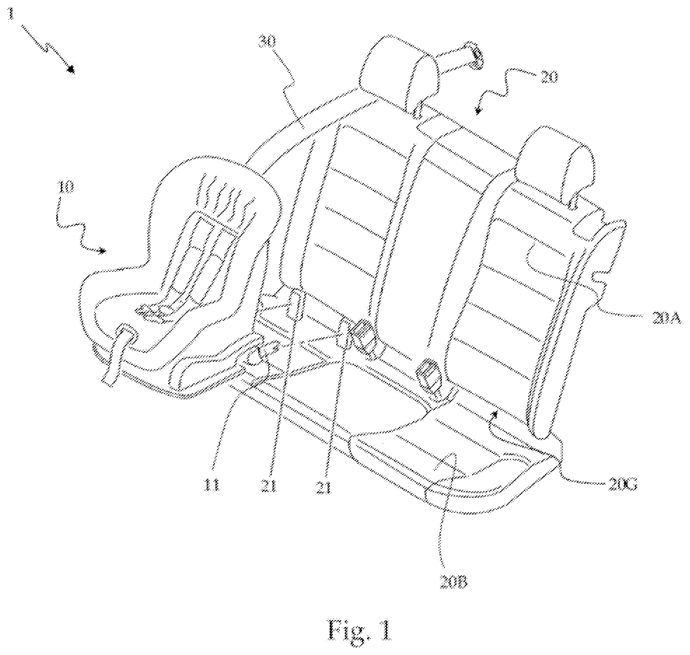

Describing now the annexed drawings, in FIG. 1 reference numeral 1 designates as a whole a system for anchoring a safety seat 10, in particular for a child, to the seat 20 of a vehicle (not shown in the annexed drawings); the seat 20 shown in FIG. 1 is a rear seat of a vehicle, but it is clear that the present invention is also applicable to a front seat of a vehicle.

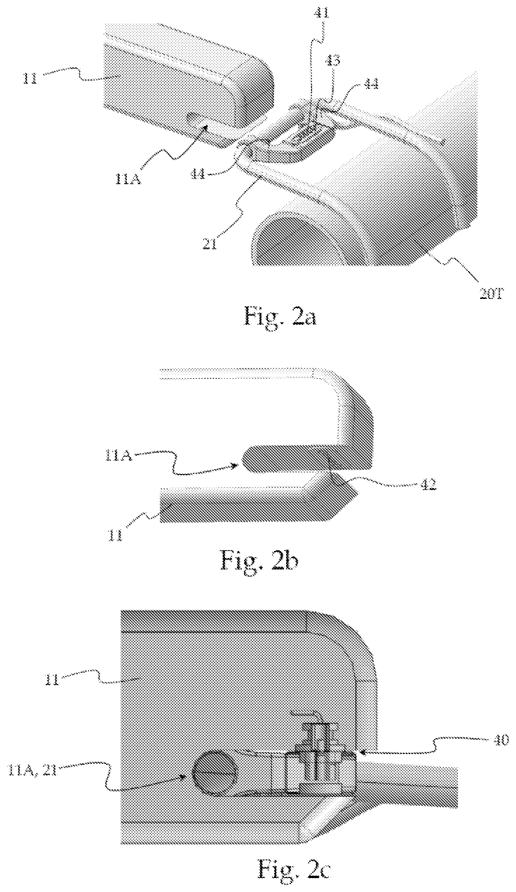

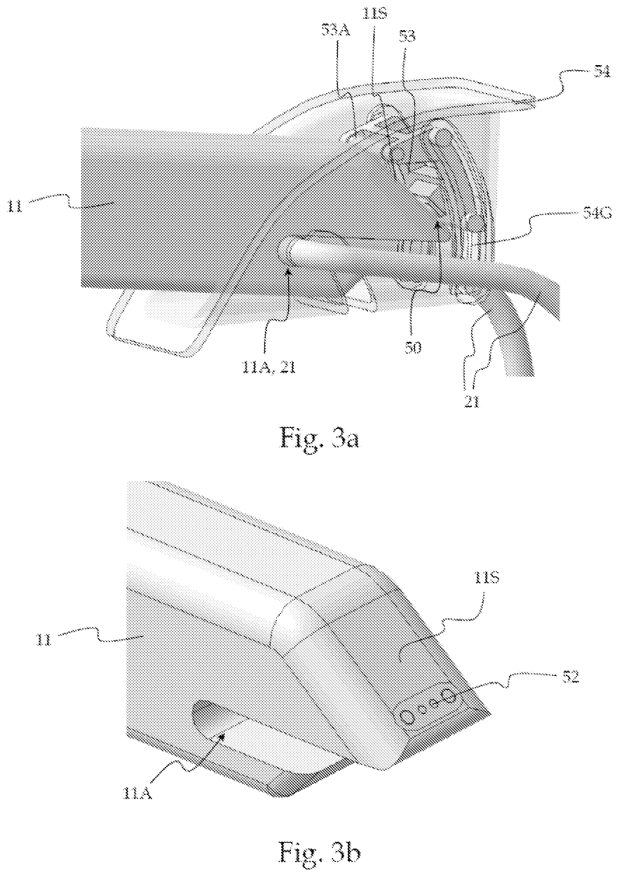

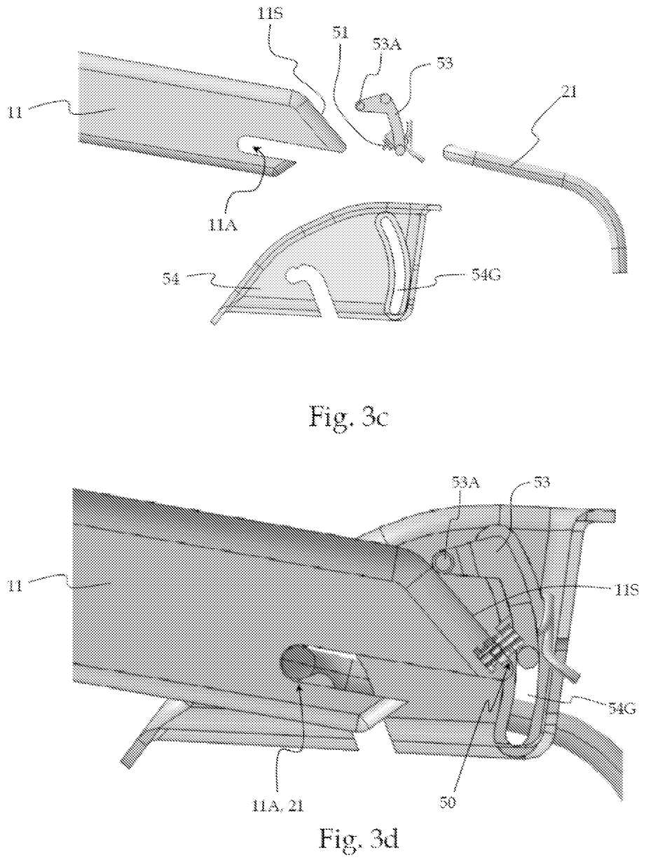

The safety seat 10 comprises at least one connector 11 comprising a housing 11A adapted to house at least a portion of an anchorage element 21 constrained to the seat 20 (as shown by way of example in FIGS. 2c, 3a and 3d); in addition, said at least one connector 11 comprises a hooking element, in particular of the clamp type with controlled opening/closing, for hooking the connector 11 to said anchorage element 21 and obtain a mechanical fastening between the safety seat 10 and the seat 20.

Basically, the system 1 is of the ISOFIX type, and is therefore made in accordance with the provisions of the international standard ISO 13216.

In this frame, the safety seat 10 comprises a pair of connectors 11 (only one of said connectors 11 is shown in FIG. 1) which can be hooked up to respective anchorage elements 21, in particular each anchorage element 21 consisting of a ring (preferably made of metallic material) fixed or welded to the seat 20; for example, each anchorage element 21 may be fixed or welded to a frame 20T of said seat 20 (or to another component of the vehicle).

Preferably, the anchorage elements 21 are positioned in a junction region 20G between a back 20A and a cushion 20B of the seat 20, in particular said anchorage elements 21 being positioned at a mutual distance of approximately 280 mm.

Furthermore, the connector 11 comprises actuating means for controlling or driving the opening and closing of the hooking element, so as to allow the connector 11 to be coupled to and decoupled from the anchorage element 21 (hence allowing the safety seat 10 to be coupled to and decoupled from the seat 20). It should be noted that said clamp-type element and the elements that control the opening/closing thereof are not shown in detail in the annexed drawings, since they are substantially made in a manner known in the art.

The system 1 may also comprise at least one anti-overturning element 30 adapted to prevent any rotational or overturning movement of the safety seat 10 relative to the seat 20. In FIG. 1 said anti- overturning element 30 consists of a safety belt; however, as is known in the art, it is clear that said anti-overturning element may alternatively consist of a different element, such as, for example, a stabilizer strap (top tether) or a foot prop (support leg).

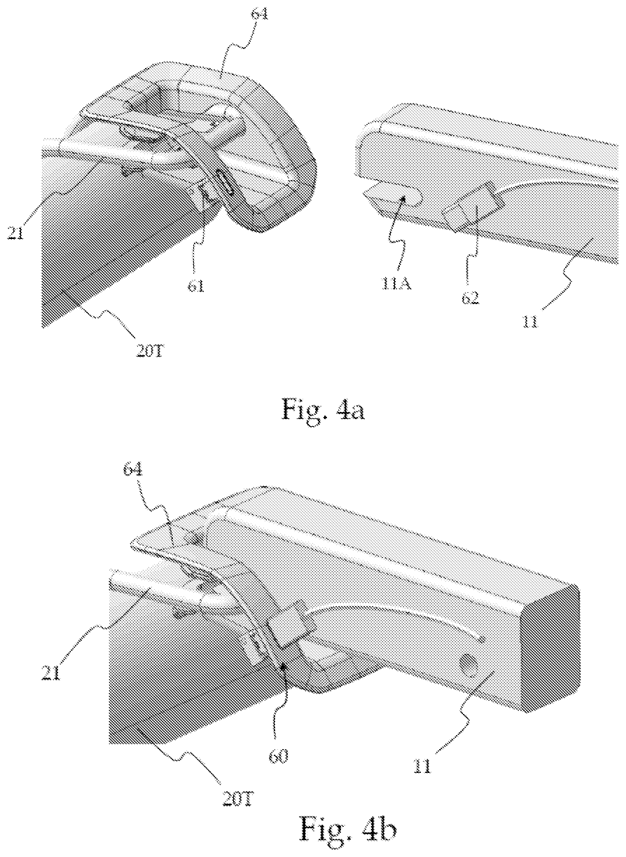

In accordance with the present invention, said at least one connector 11 and at least one anchorage element 21 comprise electric connection means (designated as a whole by reference numeral 40 in the first embodiment shown in FIGS. 2a and 2b, by reference numeral 50 in the second embodiment shown in FIGS. 3a to 3d, and by reference numeral 60 in the third embodiment shown in FIGS. 4a and 4b), which permit electric current and/or data to flow from the anchorage element 21 (i.e., from the seat 20) to the connector 11 (i.e., to the safety seat 10), and vice versa.

In particular, said electric connection means 40, 50, 60 comprise at least one first contact element (or first pin) 41, 51, 61 associated with the anchorage element 21 and at least one second contact element (or second pin) 42, 52, 62 associated with the connector 11.

In this context, with reference to a first embodiment (shown in FIGS. 2a and 2b), said electric connection means 40 comprise:
at least one first contact element 41 associated with the anchorage element 21, in particular said first contact element 41 being positioned on a support 43 connected and rotatable relative to said anchorage element 21;
at least one second contact element 42 associated with the connector 11, in particular said second contact element 42 being positioned within the housing 11A of the connector 11,
wherein said first contact element 41 is connected to the second contact element 42 when said at least a portion of the anchorage element 21 is housed in said housing 11A (and, preferably, when the hooking element of the connector 11 is in a position in which it is hooked up to, or locks, said at least a portion of the anchorage element 21).

In FIGS. 2a and 2b, the support 43 is connected with a possible rotation to said anchorage element 21 (i.e., the support 43 is connected in such a way that it can rotate relative to said anchorage element 21), in particular by means of a pair of arms 44; it is however apparent that the connection between the support 43 and the anchorage element 21 may also be established differently, e.g., by using connecting means other than the arms 44.

In accordance with an advantageous construction of the first embodiment shown in FIGS. 2a and 2b, one of said first contact element 41 and second contact element 42 consists of a spring pin (also known as “pogo pin”), while the other one of said first contact element 41 and second contact element 42 consists of a corresponding receptacle adapted to receive said spring pin (so as to establish an electric connection). In FIGS. 2a and 2b, the spring pin is the first contact element 41 associated with the anchorage element 21, and the second contact element 42 consists of a corresponding receptacle adapted to receive the spring pin; it is however clear that such elements may be reversed.

Furthermore, at least a portion of the support 43 (i.e., a portion of the support 43 which is proximal to the point where the first contact element 41 is located) and at least a portion of a region of the connector 11 whereon the second contact element 42 is positioned are made of magnetic material to facilitate the connection between said first contact element 41 and second contact element 42.

In a second embodiment (shown in FIGS. 3a to 3d), said electric connection means (designated as a whole by reference numeral 50 in FIGS. 3a and 3d) comprise:
at least one first contact element 51 associated with the anchorage element 21;
at least one second contact element 52 associated with the connector 11 and positioned outside the housing 11A of the connector 11,
wherein said first contact element 51 is connected to the second contact element 52 when said at least a portion of the anchorage element 21 is housed in said housing 11A (and, preferably, when the hooking element of the connector 11 is in a position in which it is hooked up to, or locks, said at least a portion of the anchorage element 21).

Preferably, the second contact element 52 is positioned on a surface 11S of the connector 11 that extends over the housing 11A, in particular said surface 11S extending in an inclined plane incident (preferably with an angle of less than) 90° on a plane of development of said housing 11A (as is particularly visible in the side views of the connector 11 shown in FIGS. 3c and 3d, wherein the surface 11S is substantially inclined relative to a plane of development of the housing 11A).

Furthermore, the first contact element 51 is preferably associated in a movable manner with the anchorage element 21.

In particular, the first contact element 51 is positioned on a slide 53 that slides in at least one guide 54G of a moulding 54 interposed between at least a portion of the seat 20 and at least a portion of the anchorage element 21 (i.e., that portion of the anchorage element 21 which is coupled to the connector 11), in particular said moulding 54 being fixed to the seat 20 and/or to the anchorage element 21.

The slide 53 is preferably provided with a contact element 53A adapted to abut against the surface 11S of the connector 11 and adapted to raise the slide 53 as a function of said abutment, so as to obtain the coupling between the first contact element 51 and the second contact element 52. In the embodiment shown in FIGS. 3a to 3d, said contact element 53A is shaped as a roller, in particular coupled to the slide 53 in such a way that it can rotate about its own longitudinal axis; it is however clear that the contact element 53A may also be designed otherwise, e.g., to include at least one small wheel (or the like).

In FIGS. 3a to 3d it can also be noticed that said at least one guide 54G of the moulding 54 has a substantially arched shape (as is particularly visible in FIGS. 3a, 3c and 3d); in this regard, it should be noted that the shape of said at least one guide 54G substantially corresponds to the profile of the surface 11S of the connector 11 whereon the second contact element 52 is positioned. In accordance with an advantageous construction of the second embodiment shown in FIGS. 3a to 3d, one of said first contact element 51 and second contact element 52 consists of a spring pin (also known as “pogo pin”), while the other one of said first contact element 51 and second contact element 52 consists of a receptacle adapted to receive said spring pin (thus establishing an electric connection). Also in the case shown in FIGS. 3a to 3d (as in the first embodiment shown in FIGS. 2a and 2b), the spring pin is the first contact element 51 associated with the anchorage element 21, while the second contact element 52 is represented as a respective receptacle adapted to receive said spring pin; it is however clear that such elements may be reversed.

Furthermore, at least a portion of the slide 53 (preferably, a portion of the slide 53 which is proximal to the point where the first contact element 51 is located) and at least a portion of a region of the connector 11 whereon the second contact element 52 is positioned are made of magnetic material to facilitate the connection between said first contact element 51 and second contact element 52.

Preferably, said slide 53 is associated with at least one elastic element (e.g., comprising a spring) adapted to preload said slide 53; the provision of the elastic element is also useful to damp or eliminate any vibrations transferred from the vehicle, which may impede an optimal connection between the first contact element 51 and the second contact element 52.

In accordance with a third embodiment of the system 1 according to the present invention (shown in FIGS. 4a and 4b), said electric connection means (designated as a whole by reference numeral 60 in FIG. 4b) comprise a USB (Universal Serial Bus) interface.

In this frame, the connection means 60 of the third embodiment comprise:
at least one first contact element 61 of the USB type associated with the anchorage element 21;
at least one second contact element 62 of the USB type associated with the connector 11 and positioned outside the housing 11A of said connector 11.

Preferably, said at least one second contact element 62 of the USB type is positioned on a moulding 64 interposed between at least a portion of the seat 20 and at least a portion of the anchorage element 21 (i.e., that portion of the anchorage element 21 which is coupled to the connector 11), in particular said moulding 64 being fixed to the seat 20 and/or to the anchorage element 21.

From the above description it emerges that the first embodiment and the second embodiment make it possible to obtain a substantially automatic coupling between the first contact element 41, 51 and the second contact element 42, 52, which occurs substantially at the same time as the mechanical coupling between the connector 11 and the anchorage element 21; in fact, in the first and second embodiments the coupling between the first contact element 41, 51 and the second contact element 42, 52 is accomplished by inserting and housing at least a portion of the anchorage element 21 in said housing 11A (and, preferably, when the hooking element of the connector 11 is in a position in which it is hooked up to, or locks, said at least a portion of the anchorage element 21).

As concerns the third embodiment, the coupling between the first contact element 61 and the second contact element 62 is a manual one, in that it has to be effected by a user after the mechanical coupling between the connector 11 and the anchorage element 21 has been established; in fact, in the third embodiment the coupling between the first contact element 61 and the second contact element 62 is accomplished after at least a portion of the anchorage element 21 has been inserted and housed in said housing 11A (and, preferably, also after the hooking element of the connector 11 has been brought into a position in which it is hooked up to, or locks, said at least a portion of the anchorage element 21).

Preferably, in all embodiments of the present invention the system 1 comprises a control unit (not shown) of the vehicle, wherein said control unit is connected to the electric connection means 40, 50, 60 of said at least one connector 11 and at least one anchorage element 21 for the purpose of permitting the exchange of information between said control unit and the safety seat 20.

In one embodiment, the control unit may be connected via wireless systems (e.g., 5G) and/or wired systems for the following possible scenarios:
1 Communication between the system 1 and the control unit of the vehicle;
2. Transmission of information from the vehicle to applications on mobile devices (in this case, the connection will be a wireless one, in particular a 5G connection).

For example, said exchange of information may indicate whether the safety seat 20 has been fastened to the seat 10 or not, wherein such information can be obtained even by only detecting a flow of electric current from the first contact element 41, 51, 61 of the anchorage element 21 to the second contact element 42, 52, 62 of the connector 11, and vice versa; basically, the information about whether the safety seat 20 has been fastened to the seat 10 or not can be obtained without necessarily requiring a flow of data between said first contact element 41, 51, 61 and second contact element 42, 52, 62.

The following will describe a method for anchoring a safety seat 10, in particular for a child, to the seat 20 of a vehicle.

Said method comprises the step a) of obtaining a mechanical fastening between the safety seat 10 and the seat 20 by housing at least a portion of an anchorage element 21 constrained to the seat 20 within a housing 11A of at least one connector 11 constrained to the safety seat 10. It should be noted that said mechanical fastening is accomplished in accordance with the provisions of the international standard ISO 13216.

In particular, said step a) of obtaining a mechanical fastening between the safety seat 10 and the seat 20 is carried out by activating actuating means associated with the connector 11 to control or drive the opening and closing of a hooking element, in particular of the clamp type with controlled opening/closing, of said connector 11 in order to hook up the connector 11 to said anchorage element 21.

In accordance with the present invention, the method comprises a step b) of obtaining the coupling of electric connection means 40; 50; 60 provided on both said at least one connector 11 and said anchorage element 21 to allow electric current and/or data to flow from the anchorage element 21 (i.e., from the seat 20) to the connector 11 (i.e., to the safety seat), and vice versa.

Said step b) of obtaining the coupling of the electric connection means 40; 50; 60 may be substantially automatic and occurs substantially simultaneously with the mechanical coupling between the connector 11 and the anchorage element 21.

Alternatively, said step b) of obtaining the coupling of the electric connection means 40, 50, 60 may be carried out manually after having established the mechanical coupling between the connector 11 and the anchorage element 21, in particular after at least a portion of the anchorage element 21 has been inserted and housed in said housing 11A (and, preferably, also after the hooking element of the connector 11 has been brought into a position in which it is hooked up to, or locks, said at least a portion of the anchorage element 21).

Preferably, the method according to the present invention further comprises a step c) of connecting a control unit (in particular, included in the system 1) to said electric connection means 40, 50, 60 to allow the exchange of information between said control unit and the safety seat 20.

The features of the present invention, as well as the advantages thereof, are apparent from the above description.

In particular, the fact that the connector 11 of the safety seat 10 and the respective anchorage element 21 of the seat 20 are so realized as to comprise electric connection means 40, 50, 60 to allow electric current and/or data to flow from the seat 20 to the safety seat 10 makes it possible to know with certainty if a safety seat 10 has been actually installed in the vehicle and if the installation process has been carried out correctly.

As concerns the correctness of the installation of the safety seat 10 on the seat 20, it must be pointed out that (especially with reference to the first and second embodiments of the present invention) it is implicitly confirmed when electric current and/or data are flowing correctly and without interruption, which means that the mechanical connection between the safety seat 10 and the seat 20 has been established correctly. As far as the third embodiment is concerned, the correctness of the installation of the safety seat 10 on the seat 20 can be verified directly by the user, who establishes the coupling between the first contact element 61 and the second contact element 62 after at least a portion of the anchorage element 21 has been inserted and housed in said housing 11A (and, preferably, also after the hooking element of the connector 11 has been brought into a position in which it is hooked up to, or locks, said at least a portion of the anchorage element 21).

The fact that the connector 11 of the safety seat 10 and the respective anchorage element 21 of the seat 20 are so realized as to comprise electric connection means 40, 50, 60 to allow electric current and/or data to flow from the seat 20 to the safety seat 10 also makes it possible to establish a proper connection between one or more sensors optionally arranged on the safety seat 10 and the control unit of the vehicle. It is apparent that such provisions permit an adequate management of critical scenarios, optionally envisaging the transmission of an alarm message in the event that the safety seat 10 has not been installed correctly and/or in the event that a child has been forgotten in the vehicle.

The peculiar provisions of the present invention also make it possible to provide a system 1 for anchoring a safety seat 10 to the seat 20 which can be easily manufactured and installed. For example, the electric connection means 40, 50, 60 of the present invention, which permit a flow of electric current and/or data from the seat 20 to the safety seat 10, can also be installed in existing systems.

It is therefore clear that the electric connection means 40, 50, 60 of the present invention are characterized by a wide range of applications; in particular, they can be implemented on vehicles that are not yet available on the market as well as on vehicles that are already available on the market.

The system 1 described herein by way of example may be subject to many possible variations without departing from the novelty spirit of the inventive idea; it is also clear that in the practical implementation of the invention the illustrated details may have different shapes or be replaced with other technically equivalent elements.

It can therefore be easily understood that the present invention is not limited to the above-described system 1 for anchoring a safety seat 10, in particular for a child, to the seat 20 of a vehicle, but may be subject to many modifications, improvements or replacements of equivalent parts and elements without departing from the inventive idea, as further specified in the following claims.

1. A system for anchoring a safety seat, in particular for a child, to the seat of a vehicle, wherein said safety seat comprises at least one connector comprising a housing adapted to house at least a portion of an anchorage element constrained to the seat,
wherein said at least one connector comprises a hooking element for hooking the connector to said anchorage element and obtain a mechanical fastening between the safety seat and the seat,
and wherein said at least one connector comprises actuating means for controlling or driving the opening and closing of the hooking element, so as to allow the connector to be coupled to and decoupled from the anchorage element,
wherein said at least one connector and said at least one anchorage element comprise electric connection means that permit electric current and/or data to flow from the anchorage element to the connector, and vice versa.

2. The system according to claim 1, wherein said electric connection means comprise at least one first contact element associated with the anchorage element and one second contact element associated with the connector.

3. The system according to claim 1, wherein said electric connection means comprise:
at least one first contact element associated with the anchorage element, in particular said first contact element being positioned on a support connected and rotatable relative to said anchorage element;
at least one second contact element associated with the connector, in particular said second contact element being positioned within the housing of the connector,
wherein said first contact element is connected to the second contact element when said at least a portion of the anchorage element is housed in said housing.

4. The system according to claim 3, wherein said support is connected and rotatable relative to said anchorage element.

5. The system according to claim 1, wherein one of said first contact element and second contact element consists of a spring pin and the other one of said first contact element and second contact element consists of a corresponding receptacle adapted to receive said spring pin.

6. The system according to claim 1, wherein at least a portion of the support and at least a portion of a region of the connector whereon the second contact element is positioned are made of magnetic material to facilitate the connection between said first contact element and second contact element.

7. The system according to claim 1, wherein said electric connection means comprise:
at least one first contact element associated with the anchorage element;
at least one second contact element associated with the connector and positioned outside the housing of the connector,
wherein said first contact element is connected to the second contact element when said at least a portion of the anchorage element is housed in said housing.

8. The system according to claim 7, wherein the second contact element is positioned on a surface of the connector that extends over the housing, in particular said surface extending in an inclined plane incident on a plane of development of said housing.

9. The system according to claim 7, wherein the first contact element is movably associated with the anchorage element.

10. The system according to claim 9, wherein the first contact element is positioned on a slide that slides in at least one guide of a moulding interposed between at least a portion of the seat and at least a portion of the anchorage element.

11. The system according to claim 10, wherein said slide is provided with a contact element adapted to abut against the surface of the connector and adapted to raise the slide as a function of said abutment, so as to obtain the coupling between the first contact element and the second contact element.

12. The system according to claim 7, wherein one of said first contact element and second contact element consists of a spring pin and the other one of said first contact element and second contact element consists of a receptacle adapted to receive said spring pin.

13. The system according to claim 7, wherein at least a portion of the slide and at least a portion of a region of the connector whereon the second contact element is positioned are made of magnetic material to facilitate the connection between said first contact element and second contact element.

14. The system according to claim 1, wherein said electric connection means comprise:
at least one first contact element of the USB type associated with the anchorage element;
at least one second contact element of the USB type associated with the connector and positioned outside the housing of said connector.

15. The system according to claim 14, wherein said at least one second contact element of the USB type is positioned on a moulding interposed between at least a portion of the seat and at least a portion of the anchorage element.

16. A method for anchoring a safety seat, in particular for a child, to the seat of a vehicle, wherein said method comprises a step a) of obtaining a mechanical fastening between the safety seat and the seat by housing at least a portion of an anchorage element constrained to the seat within a housing of at least one connector constrained to the safety seat,
said method comprising a step b) of obtaining the coupling of electric connection means provided on said at least one connector and on said anchorage element to allow electric current and/or data to flow from the anchorage element to the connector, and vice versa.

17. The method according to claim 16, wherein said step b) of obtaining the coupling of the electric connection means is substantially automatic and occurs substantially simultaneously with the mechanical coupling between the connector and the anchorage element.

18. The method according to claim 16, wherein said step b) of obtaining the coupling of the electric connection means is substantially manual and is carried out after having mechanically coupled the connector to the anchorage element .

19. The method according to claim 16, comprising a step c) of connecting a control unit to said electric connection means to allow the exchange of information between said control unit and the safety seat.

20. The method according to claim 16, wherein said step a) of obtaining a mechanical fastening between the safety seat and the seat is carried out by activating actuating means associated with the connector to control or drive the opening and closing of a hooking element, in particular of the clamp type with controlled opening/closing, of said connector in order to hook up the connector to said anchorage element.
